(19) United States
(12) Patent Application Publication
(10) Pub. No.: US 2020/0298224 A1
(43) Pub. Date: Sep. 24, 2020

(54) SYSTEM AND METHOD FOR CATALYST REMOVAL FROM MTO EFFLUENT

(71) Applicants: Michael J. Tallman, Houston, TX (US); Yanbo Li, Beijing (CN)

(72) Inventors: Michael J. Tallman, Houston, TX (US); Yanbo Li, Beijing (CN)

(73) Assignee: Kellogg Brown & Root LLC, Houston, TX (US)

(21) Appl. No.: 16/823,701

(22) Filed: Mar. 19, 2020

Related U.S. Application Data
(60) Provisional application No. 62/821,686, filed on Mar. 21, 2019.

(51) Int. Cl. B01J 38/50; B01J 19/32; B01D 11/04

(52) U.S. Cl. CPC B01J 38/50; B01D 11/0488; B01D 11/0492; B01J 19/32

(57) ABSTRACT

According to the invention a system and method for catalyst removal from MTO effluent is provided. The method includes removing catalyst from methanol to olefin effluent including contacting the methanol to olefin effluent with a wash oil separate the catalyst fines from the effluent into the wash oil and cool the effluent, separating the catalyst fines from the cooled effluent in a separator or a column to obtain an essentially catalyst free effluent, directing the catalyst free effluent out from the separator or the column, slurrying the separated catalyst fines to obtain a slurry and directing the slurry to one or more filters to filter out the catalyst.

### CROSS REFERENCE TO RELATED APPLICATION

This application claims priority to U.S. Provisional patent application having Ser. No. 62/821,686 filed on Mar. 21, 2019 which is incorporated by reference herein.

### FIELD

Embodiments of the present invention relate generally to catalyst removal and more particularly to the catalyst removal from MTO effluents.

### BACKGROUND

Methanol to Olefins (MTO) is a preferred technology for olefins production in regions where there is availability of methanol for feed, or abundance of coal which can be converted to methanol via several processing steps.

Olefins are typically produced by converting a hydrocarbon feed at a high temperature to provide a hydrocarbon mixture containing various alkane, alkene, and alkyne hydrocarbons. The hydrocarbon mixture is then fractionated using a series of distillation columns, fractionation columns, compressors, and refrigeration systems to cool, condense, and separate the various hydrocarbon products.

Operating MTO plants have experienced difficulties due to catalyst fines contained in the reactor effluent. Since MTO reactor effluent contains a large quantity of water, a water quench tower is used to cool the reactor effluent and condense the water. The catalyst fines contained in the reactor effluent stream cannot easily be separated from quench water and as a result excessive fouling occurs in equipment with consequential high maintenance costs.

Hence, there is a need for an improved system and method for removing catalyst fines from MTO effluent stream.

### SUMMARY

Briefly in accordance with aspects of the present technique, a method for catalyst removal from MTO effluent is provided. The method includes removing catalyst from ethanol to olefin effluent by contacting the methanol to olefin effluent with a wash oil to cool the effluent to obtain a cooled effluent, separating the catalyst fines from the cooled effluent in a separator or a column to obtain an essentially catalyst free effluent, directing the catalyst free effluent out from the separator or the column, slurrying the separated catalyst fines to obtain a slurry and directing the slurry to one or more filters to filter out the catalyst.

In accordance with another aspect of the present technique, a system for removing catalyst from MTO effluent is provided. The system includes a quench tower having an inlet for receiving MTO effluent, vapor liquid contacting elements disposed above the inlet for cooling the effluent and washing out fines, an outlet above the contacting elements for discharging the cooled effluent essentially free of catalyst fines, and a liquid hold up zone below the inlet for collecting a wash oil from the contacting elements; a recirculation loop for continuously recirculating the wash oil from the liquid hold up zone to the contacting elements; at least two filters alternatingly operable in filtration and backflushing modes; a filtration loop for circulating a slurry comprising catalyst fines and wash oil through a filtration mode filter and returning a filtrate to the quench tower; a backflushing loop for passing a compressed gas through the backflush mode filter for removal of catalyst fines from the slurry; and a catalyst accumulator for accumulating the catalyst fines obtained from the filters.

### BRIEF DESCRIPTION OF THE DRAWINGS

The present invention will be described in greater detail with references to the accompanying figure wherein;

FIG. 1 is a process flow diagram depicting an embodiment of catalyst removal from methanol to olefin effluent with downstream oil/vapor separation vessel and associated filters;

FIG. 2 is a process flow diagram depicting catalyst removal from methanol to olefin effluent, in accordance with another embodiment; and

FIG. 3 is a process flow diagram depicting catalyst removal from methanol to olefin effluent, in accordance with another embodiment of the present technique.

### DETAILED DESCRIPTION

The description of the embodiments and applications of the present invention is being done together with the accompanying drawings, which form a part hereof. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting.

The terms “a” and “an” herein do not denote a limitation of quantity, but rather denote the presence of at least one of the referenced item.

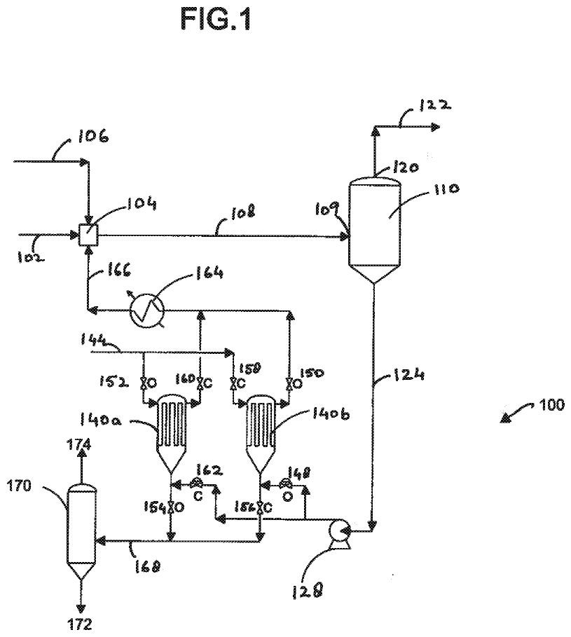

With reference to FIG. 1 a schematic process flow diagram 100 of catalyst removal from MTO effluent is presented. An MTO effluent is introduced via line 102 to a quench fitting 104, where it is mixed with a wash oil introduced via line 106 to obtain a cooled effluent 108 which is directed to a separator or a column 110 via line 108 through an inlet 109.

The separator or column 110 may include separation elements such as contacting elements, packing material or trays (not shown) to separate the catalyst fines from the effluent.

In accordance with the aspects of the present technique, the separator or column 110 separates out the catalyst fines from the effluent, which is thereafter directed to an outlet 120 for discharging the cooled effluent essentially free of catalyst fines via line 122 for further processing, preferably to a water quench tower (not shown). The water quench tower is adapted to further cool the effluent and condense the water from the effluent.

The separated catalyst fines are directed out of the separator or the column 110 via line 124 in a slurried form which is circulated by a slurry circulating pump 128. The slurry is circulated to one or more filters 140a, 140b, via the pump 128 for filtering out the catalyst therefrom and thereafter returning a filtrate to the quench fitting 104.

Backflush gaseous medium is provided via line 144 to pressurize and flush the collected catalyst fines into line 168. The backflush medium which may be compressed gas that may be selected from an inert gas, air and/or fuel gas. One of the filters 140a or 140b is in filter mode, while the other is in backflush mode. For example, valves 148, 150, 152 and 154 are open and valves 156, 158, 160 and 162 are closed when filter 140b is filtering and filter 140a is being backflushed, as depicted in FIG. 1; the valves are switched after the catalyst fines have accumulated in filter 140b and the filter 140b is ready for backflushing. The filtration is preferably continuous and should be at a rate that keeps the fines level from building to excessive levels in the wash oil, preferably no more than 0.5 weight percent fines, more preferably no more than 0.2 weight percent, and yet more preferably no more than 0.1 weight percent fines in the wash oil.

In accordance with aspects of the present technique, a catalyst accumulator 170 connected to the filters 140a, 140b via line 168 accumulates the catalyst fines from the filters 140a, 140b. The catalyst fines and wash oil are removed from the system from the accumulator 170 via line 172 from the bottom of accumulator 170, while the backflush gaseous medium is removed from the system from the accumulator 170 via line 174 from the top of accumulator 170.

It may be noted that heat removal heat exchangers may also be present in line 166 for cooling the MTO effluent typically encompassing but limited to a steam generator 164 as depicted in FIG. 1.

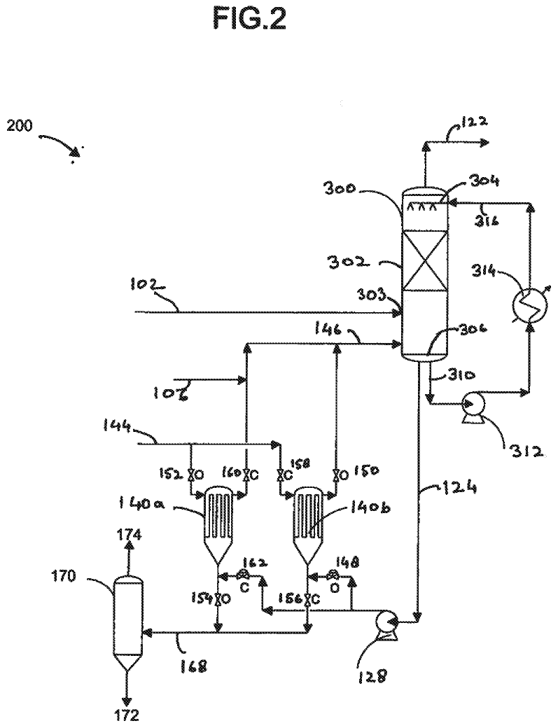

Referring now to FIG. 2, another embodiment depicting a process flow 200 for separating catalyst fines from MTO effluent is depicted. The embodiment includes an oil quench tower 300, the MTO effluent and the wash oil is supplied to the oil quench tower via lines 102 and 106 respectively. It may be noted that the entrained catalyst is washed from the MTO effluent by contact with the circulating wash oil. Overhead vapor from the tower 300 in line 122 is routed preferably to a water quench tower (not shown) at a typical temperature of 200-400° F. for recovery of MTO effluent.

The quench tower includes a vapor-liquid contacting zone 302 which can include conventional packing or trays that may be disposed above a liquid holdup zone 306. MTO Effluent from line 102 is introduced below the contacting zone 302 through an inlet 303. A recirculation loop 310 which includes a circulating pump 312, heat removal heat exchangers 314, typically encompassing but not limited to a steam generator 314, and the line 316 is configured to introduce a continuous supply of wash oil to a liquid distributor 304 above the contacting zone 302, In the contacting zone 302, the catalyst fines in the effluent are washed into the oil, and the MTO effluent is cooled and separated.

It may be noted that the MTO effluent enters the quench tower 300 at a temperature of 800-1000′F and exits at a temperature from about 200-400° F.

A filtration loop 124 includes a slurry circulating pump 128, filters 140a, 140b and the line 146 for returning filtrate to the oil quench tower 300. Backflush gaseous medium is provided via line 144 to pressurize and flush the collected catalyst fines into line 168. As previously noted with reference to FIG. 1, the backflush medius is a compressed gas medium that can be selected from an inert gas, air and fuel gas. One of the filters 140a or 140b is in filter mode, while the other is in backflush mode. For example, valves 148, 150, 152 and 154 are open and valves 156, 158, 160 and 162 are closed when filter 140b is filtering, that is in filter mode and filter 140a is being backflushed, that is in backflush mode, as depicted in FIG. 2; the valves are switched after the fines have accumulated in filter 140b and the filter 140b is ready for backflushing. The filtration is preferably continuous and should be at a rate that keeps the fines level from building to excessive levels in the wash oil, preferably no more than 0.5 weight percent fines, more preferably no more than 0.2 weight percent, and yet more preferably no more than 0.1 weight percent fines in the wash oil. The catalyst fines obtained from the filters 140a, 140b is directed to the catalyst accumulator 170 via line 168. The catalyst fines and wash oil are removed from the system from the accumulator 170 via line 172 from the bottom of accumulator 170, while the backflush gaseous medium is removed from the system from the accumulator 170 via line 174 from the top of accumulator 170.

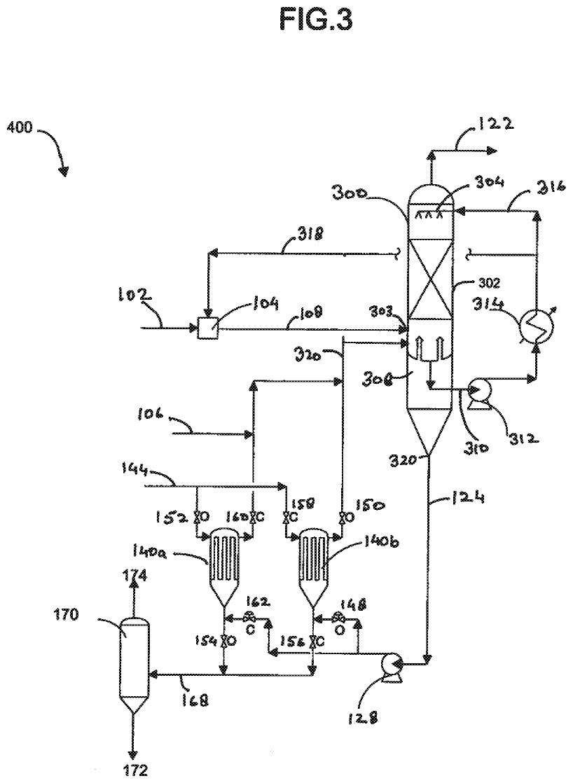

Turning now to FIG. 3, an embodiment depicting a schematic process flow 400 of removing catalyst from methanol to olefin effluent is presented. An MTO effluent is introduced via line 102 to the quench fitting 104, where it is mixed with the wash oil that is fed into the quench fitting via line 318. The wash oil via line 106 may be directly fed to the quench fitting 104 or may be recirculated from the oil quench tower 300. The MTO effluent mixed with oil is fed into the oil quench tower 300.

As previously noted, the entrained catalyst is washed from the MTO effluent by contact with the circulating wash oil. Overhead vapor from the tower 300 in line 122 is routed most frequently to a water quench tower (not shown) at a typical temperature of 200-400° F.

According to the present embodiment, the quench tower 300 includes a vapor-liquid contacting zone 302 which can include conventional packing or trays, disposed above a separation zone 308. The separation zone 308 is located at the bottom of the quench tower 300 and is adapted to separate vapors from liquids. MTO Effluent from line 108 is introduced below the contacting zone 302. A recirculation loop 310 which includes the wash oil circulating pump 312, heat removal heat exchangers 314, typically encompassing but not limited to a steam generator 314, and a line 316 to introduce a continuous supply of wash oil to a liquid distributor 304 above the contacting zone 302. In the contacting zone 302, the catalyst fines in the effluent are washed into the oil, and the MTO effluent is cooled. A slurry is obtained from the mixture of catalyst and wash oil, which settles at the bottom of the quench tower 300 and directed through an outlet 320 into a filtration loop 124.

As previously noted, the MTO effluent enters the quench tower 300 at a temperature of 800-1000° F. and exits at a temperature from about 200-400° F. The filtration loop 124 includes a slurry circulating pump 128, filters 140a, 140b and the line 320 for returning filtrate to the oil quench tower 300. Backflush gaseous medium is provided via line 144 to pressurize and flush the collected catalyst fines into line 168. As previously noted with reference to FIG. 1, the backflush medium is a compressed gas medium that can be selected from an inert gas, air and fuel gas. One of the filters 140a or 140b is in filter mode, while the other is in backflush mode. For example, valves 148, 150, 152 and 154 are open and valves 156, 158, 160 and 162 are closed when filter 140b is filtering, that is in filter mode, and filter 140a is being backflushed, that is in backflush mode, as depicted in FIG. 3; the valves are switched after the fines have accumulated in filter 140b and the filter 140b is ready for backflushing. The filtration is preferably continuous and should be at a rate that keeps the fines level from building to excessive levels in the wash oil, preferably no more than 0.5 weight percent fines, more preferably no more than 0.2 weight percent, and yet more preferably no more than 0.1 weight percent fines in the wash oil. The catalyst fines obtained from the filters 140a, 140b is directed to the catalyst accumulator 170 via line 168. The catalyst fines and wash oil are removed from the system from the accumulator 170 via line 172 from the bottom of accumulator 170, while the backflush gaseous medium is removed from the system from the accumulator 170 via line 174 from the top of accumulator 170.

In accordance with aspects of the present technique, a portion of the wash oil in the quench tower 300 may be recirculated to the quench fitting 104 via line 318. Furthermore, the wash oil can also be supplied to the quench fitting continuously from a wash oil source via line 106 to maintain a steady amount of wash oil in the quench fitting.

Embodiments of the present invention have several advantages over the existing techniques, such as but not limited to ease of separation of catalyst fines and recovery, resulting in low maintenance cost of the equipment.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A method for recovering catalyst from a methanol to olefin effluent, the method comprising:
a) contacting methanol to olefin effluent with wash oil to separate catalyst fines from the effluent;
b) withdrawing slurry comprising catalyst fines and wash oil from the cooled effluent in a separator or column to obtain an essentially catalyst free effluent;
c) filtering the slurry by at least one filter through slurry circulating pump;
d) returning the filtered wash oil from filter to quench fitting as a recirculated wash oil;
e) back flushing the filter by gaseous medium to flush the catalyst fines; and
f) collecting the catalyst fines from a accumulator.

2. The method of claim 1 further comprising recirculated wash oil is routed to contact with methanol to olefin effluent.

3. The method of claim 1 where circulating the oil-catalyst slurry through a filter comprises continuously passing the oil-catalyst slurry through at least one first filter in a filtration mode to separate the catalyst therefrom giving filtrate while at least one second filter in parallel with the first filter is in a backwashing mode thereby removing the separated catalyst therefrom.

4. The method of claim 1 further comprising returning filtrate from the filter to the oil quench.

5. The method of claim 3 where the backwashing of the at least one filter further comprises periodically alternating the at least one first and the at least one second filters between the filtration and backwashing modes.

6. The method of claim 1 where the backwashing includes at least once pulsing compressed gas through the second filter for catalyst removal.

7. The method of claim 1 where the filter is a continuous filtration system, where in the method the circulating the oil-catalyst slurry through the continuous filtration system comprises:
(a) continuously removing catalyst from the inside surface; and
(b) continuously removing concentrated oil-catalyst slurry and routing it to a reactor generator.

8. The method of claim 1 where the filter is a multi-bed system comprising multiple beds each bed comprising a fixed filtration medium, where in the method the circulating the oil-catalyst slurry through the multi-bed system further comprises:
(a) circulating the oil-catalyst slurry through at least a first bed therefrom,
(b) a second filter in parallel with the first filter is in backflushing mode to remove the separated catalyst fines therefrom.

9. The method of claim 1 where in the method contacting the effluent gas with wash oil occurs in a direct contact inline device prior to entering a flash zone, followed by removing a net amount of wash oil and a majority of the catalyst as a concentrated bottom oil-catalyst slurry.

10. The method of claim 1 further comprising introducing at least a portion of the wash oil from wash section is recycled to top of oil quench tower through circulating pump and heat exchanger.

11. The method of claim 1 where in the separator or column having vapor-liquid contacting element comprising packing material or trays.

12. The method of claim 1 where in the gaseous medium is selected from an inert gas, or and fuel gas.

13. A system for recovering catalyst from a methanol to olefin effluent, the system comprising:
(a) a quench tower having an inlet for receiving the effluent and wash oil;
(b) vapor-liquid contacting elements disposed above the inlet for cooling the effluent and washing out the catalyst;
(c) a vapor outlet above the contacting elements for discharging cooled effluent gas essentially free of catalyst, and a liquid holdup zone below the inlet for collecting the wash oil from the contacting elements;
(d) at least one filter operable in filtration and back flushing modes;
(e) a filtration loop for circulating wash oil from the liquid holdup zone through a filter and returning filtrate to the quench tower; and
(f) a catalyst accumulator collects catalyst fine.

14. The system of claim 13 where the filter comprises a multi-bed system comprising multiple beds, each bed comprising a fixed filtration medium.

15. The system of claim 13 where the filter is a continuous filtration system.

16. The system of claim 13 further comprising introducing at least a portion of the wash oil from the liquid holdup zone is recycled to top of oil quench tower through circulating pump and heat exchanger.

17. The system of claim 13 where in the vapor-liquid contacting element comprising packing material or trays.

18. The system of claim 13, wherein the catalyst accumulator is adapted to remove the catalyst fines with wash oil from a first end and further adapted to backflush vapor from a second end.
